(19) United States
(12) Patent Application Publication
(10) Pub. No.: US 2017/0357945 A1
(43) Pub. Date: Dec. 14, 2017

(54) AUTOMATED MATCHING OF JOB CANDIDATES AND JOB LISTINGS FOR RECRUITMENT

(71) Applicant: Recruiter.AI, Inc., Palo Alto, CA (US)

(72) Inventors: Amir Ashkenazi, Los Altos, CA (US); Lior Amram, Foster City, CA (US)

(21) Appl. No.: 15/622,956

(22) Filed: Jun. 14, 2017

Related U.S. Application Data
(60) Provisional application No. 62/426,168, filed on Nov. 23, 2016.
(60) Provisional application No. 62/350,179, filed on Jun. 14, 2016.

(51) Int. Cl. G06Q 10/10; G06Q 10/04; G06Q 10/06

(52) U.S. Cl. CPC G06Q 10/1053; G06Q 10/0631; G06Q 10/105; G06Q 10/04; G06Q 10/06312; G06Q 10/06; G06Q 10/047; G06Q 10/10

(57) ABSTRACT

An automated recruitment platform determines based on a candidate's work history, one or more matching job listings. For each candidate, a recruitment engine receives work history information, including a past or present job title and company. The recruitment engine receives job listings from employers. The recruitment engine uses a machine learning model to determine whether a job listing is a likely next job for a candidate based on the candidate's work history and the job listing. The recruitment engine provides this information to employers and/or further determines matching jobs based on candidate information and candidate job preferences. The recruitment engine facilitates communication between employers and candidates, including interview offers.

### CROSS REFERENCE TO RELATED APPLICATIONS

This applications claims the benefit of U.S. Provisional Application No. 62/350,179, filed Jun. 14, 2016, and U.S. Provisional Application No. 62/426,168, filed Nov. 23, 2016, each of which is incorporated herein by reference in their entirety.

### TECHNICAL FIELD

This disclosure relates to candidate selection for purposes of recruitment, and more specifically, to automatically determining matches between job candidates and job listings.

### BACKGROUND

Despite significant advancements in artificial intelligence and machine learning, candidate recruitment in the software and technology industries remains a mostly manual process. Recruiting professionals must personally review tens or even hundreds of resumes and reach out and screen candidates individually. There is a need for a digital system that can perform automated identification, screening, and selection of candidates on behalf of human recruiters, thereby increasing the accuracy and efficiency of the recruiting process.

### SUMMARY

Example embodiments discussed herein related managing recruitment of candidates. Some embodiments include an automated system for managing the recruitment of the candidates. A system, and corresponding method (or process) and program code, may include a candidate application module, an employer application module, a prediction module, and a matching module. The candidate application module receives candidate work history of a candidate, the candidate work history comprising a past job title and a past company name. The employer application module receives a job listing, the job listing including a listing job title and a listing company name. The prediction module determines, by applying the candidate work history and job listing to a machine learning model, a job prediction score indicating a measure of whether the job listing is a likely next job for the candidate, the machine learning model including model parameters defining a relationship between the job prediction score and the candidate work history and job listing. The matching module determines, based on the job prediction score, whether the candidate is a match for the job listing. In some embodiments, the system further includes a training module that generates the machine learning model.

The disclosed example embodiments may include a method (or process), along with corresponding system and corresponding program code, for managing recruitment of candidates. By way of example, the process may include receiving candidate work history of a candidate, the candidate work history comprising a past job title and a past company name; and receiving a job listing, the job listing including a listing job title and a listing company name. The method further includes determining, by applying the candidate work history and job listing to a machine learning model, a job prediction score indicating a measure of whether the job listing is a likely next job for the candidate, the machine learning model including model parameters defining a relationship between the job prediction score and the candidate work history and job listing. The method further includes determining, based on the job prediction score, whether the candidate is a match for the job listing.

Some example embodiments include a non-transitory computer readable medium storing the program code (or software). The program code comprises instructions that, when executed by one or more processors, configures the processor to: receive candidate work history of a candidate, the candidate work history comprising a past job title and a past company name; receive a job listing, the job listing including a listing job title and a listing company name; determine, by applying the candidate work history and job listing to a machine learning model, a job prediction score indicating a measure of whether the job listing is a likely next job for the candidate, the machine learning model including model parameters defining a relationship between the job prediction score and the candidate work history and job listing; and determine, based on the job prediction score, whether the candidate is a match for the job listing.

### BRIEF DESCRIPTIONS OF THE DRAWINGS

The disclosed embodiments have other advantages and features which will be more readily apparent from the following detailed description of the invention and the appended claims, when taken in conjunction with the accompanying drawings, in which:

FIG. 1 is a diagram of the environment of an automated recruiter platform, according to one embodiment.

FIG. 2 is a diagram of an automated recruitment engine, according to one embodiment.

FIG. 3 is a diagram of a process for generating candidate summaries, according to one embodiment.

FIG. 4 is a flowchart describing the process of generating a candidate summary, according to one embodiment.

FIG. 5 is a flowchart describing the process of selecting candidates in response to requirements provided by a recruiter, according to one embodiment.

FIG. 6 is a block diagram illustrating components of an example machine able to read instructions from a machine-readable medium and execute them in a processor (or controller).

FIGS. 7A-7K illustrate an example user interface for a candidate application, according to one embodiment.

FIGS. 8A-I illustrate an example user interface for employer application that is a web browser extension, according to one embodiment.

FIG. 9 illustrates example user interface elements for indicating a prediction score, according to one embodiment.

FIG. 10 illustrates an example user interface for an employer application that includes candidate information, candidate work history, and prediction score indicators, according to one embodiment.

### DETAILED DESCRIPTION

The figures and the following description relate to preferred embodiments by way of illustration only. It should be noted that from the following discussion, alternative embodiments of the structures and methods disclosed herein will be readily recognized as viable alternatives that may be employed without departing from the principles of what is claimed.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

### Configuration Overview

An automated recruitment platform determines, based on a candidate's work history, one or more matching job listings. A candidate is an individual (or set of individuals) that may potentially fill a position (or set of positions), e.g., for employment. The position may be a job. For each candidate, a recruitment engine may be configured to receive work history information, including a past or present job title and company. The recruitment engine may receive job listings from employers. The recruitment engine may apply a mathematical model (e.g., rules executable by a computer system) to determine whether a job listing is a likely next job for a candidate based on a work history for the candidate. The recruitment engine may provide this information to employers and/or further determine matching jobs based on candidate information and candidate job preferences. The recruitment engine also may facilitate communication between employers and candidates, including offers for interviewing.

### Environment of an Automated Recruitment Platform

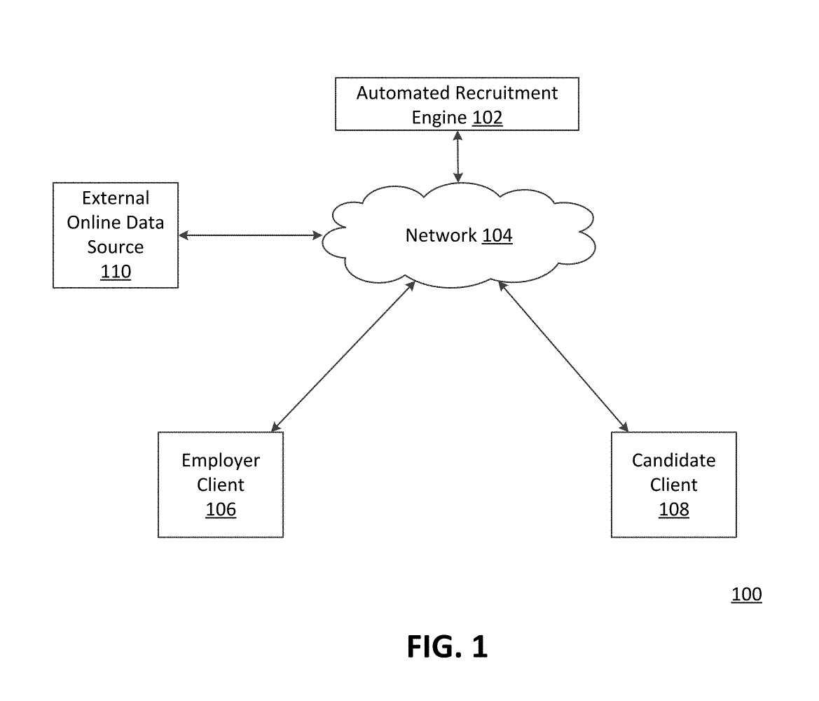

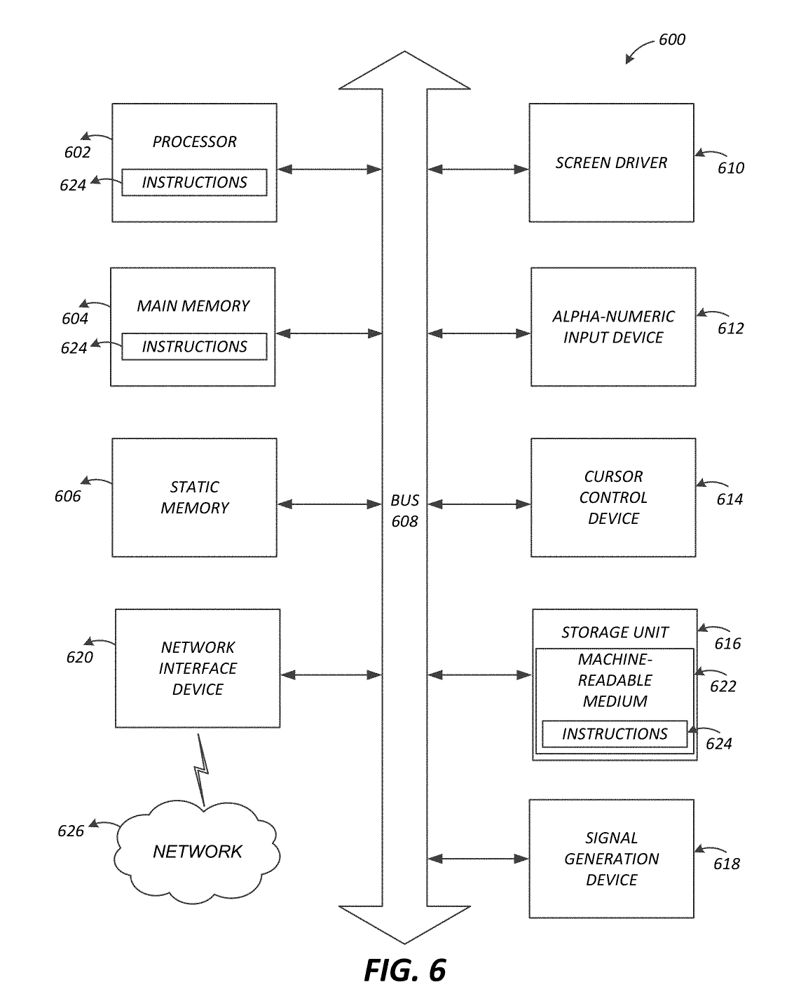

FIG. 1 illustrates an example environment of an automated recruiter platform, according to one example embodiment. The environment 100 may include an automated recruitment engine 102, one or more employer clients 106, one or more candidate clients 108, and one or more external online data sources 110. The employer client 106 corresponds to an electronic account established for an entity, e.g., employer, seeking to potentially fill a position (or set of positions). The candidate client 108 corresponds to an electronic account established for an individual (or set of individuals) to fill a potential position (or set of positions), e.g., as determined by the employer client 106. The automated recruitment engine 102, the employer clients 106, the candidate clients 108, and the external online data sources may be computing devices that are communicatively connected through a network 104. These computing devices may have an architecture comprises of components (in part or in whole) as described with, for example, FIG. 6. In addition, these computing device may be configured to operate as described herein.

The automated recruitment engine 102 may be configured to automatically identify matches between job listings and candidates. The matches may be in response to requests/input provided by candidates and employers. The automated recruitment engine 102 is communicatively coupled via a network 104 to one or more employer clients 106. For ease of discussion, and by way of example, one employer client 106 is depicted in FIG. 1. It is noted that tens, hundreds, or thousands of employer clients 106 may be connected to the automated recruitment engine 102. An employer client 106 may include hardware, software, or some combination thereof and provides functionality for communicating with the automated recruitment engine 102. The employer client 106 may provide an employer application. The employer application may be, for example, a web interface or standalone software application. The employer application is configured to receive and/or transmit data from an employer (e.g., a company seeing to hire candidates) representative, e.g., an internal or external recruiter or artificial intelligence (AI) engine configured to execute rules for determining data that the employer would like to see based on data analyzed by the AI engine. The data may be, for example, company information, job listing information, candidates for consideration and/or review, extension of offers to candidates, and other information for communication between the employer and candidate.

The engine 102 is further communicatively coupled to one or more candidate clients 108. For ease of discussion, one candidate client 108 is depicted. It is noted that hundreds, thousands, or millions of candidate clients may be connected to the automated recruitment engine 102. A candidate client 108 may include hardware, software, or some combination thereof and provides functionality for communicating with the automated recruitment engine 102. The candidate client 108 may provide a candidate application, such as a web interface or standalone software application that allows a candidate (e.g., a prospective employee) or a representative thereof (e.g., a recruiter) to provide work history, job preferences, and candidate information, receive and review job offers, and communicate with employers.

The engine 102 also is coupled to one or more external online data sources 110. Each data source 110 contains information describing or associated with a candidate, a candidate's work history, qualifications, former companies, etc. The information may be unstructured or structured data. Example external online data sources 110 include professional data sources (e.g., LINKEDIN, MONSTER, or employee biography websites) or social data sources (e.g., FACEBOOK, TWITTER, PINTEREST, or GOOGLE PLUS). The external online data source also may include sites in which an individual may be active with regard to contributions, for example, professional forums or contribution sites (e.g., professional advice contribution sites, software coding contribution sites). The automated recruitment engine 102 extracts information relevant to a particular candidate from each of the available data sources 110. Examples of relevant information may include, for example, name, current employer, past employer, current position, past position, education, project (or work) experiences and the like.

### Contents of an Automated Recruitment Engine

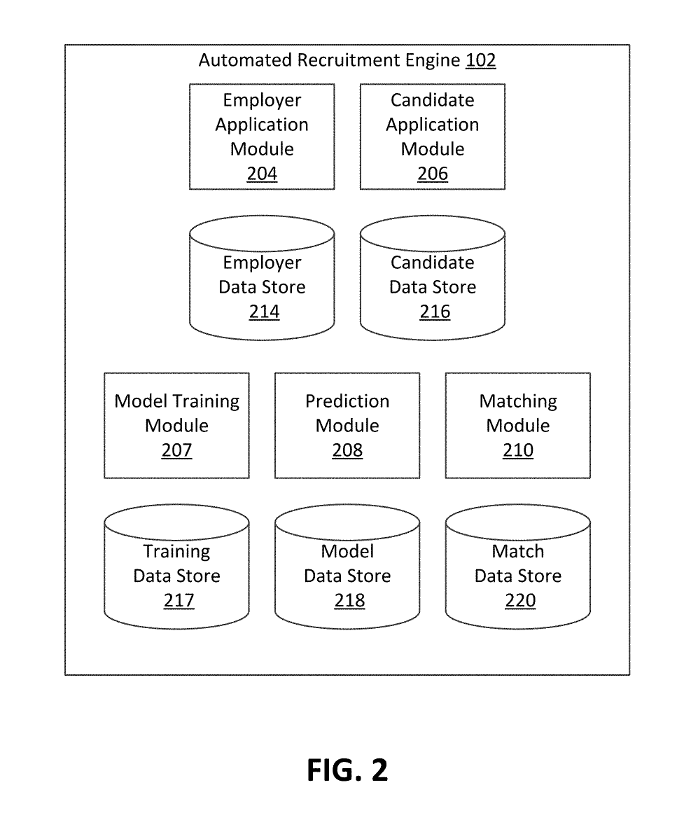

FIG. 2 is a diagram of an automated recruitment engine, according to one example embodiment. The example automated recruitment engine 102 includes an employer application module 204, an employer data store 214, a candidate application module 206, a candidate data store 216, a model training module 207, a training data store 217, a prediction module 208, a model data store 218, a matching module 210, and a match data store 210.

The employer application module 204 may be configured to manage communications and data transfer between the automated recruitment engine 102 and employer clients 106, for example, via the employer application. In one embodiment, the employer application is a standalone software application running on an employer client 106. In another embodiment, the employer application is a web interface provided by the employer application module 204 and accessible via a web browser on an employer client 106. The employer application module 204 receives job listing information and company information from employer clients 106 and external data sources 110. Job listing information describes a job at an employer. Job listing information may include, for example, a company name, a job title, a job location, compensation information, benefits, commute information, company information, etc. Company information describes an employer. Company information may include, for example, company location, website, employee count, key benefits, industry categories, a company description, team members, etc. Information received by the employer application module 204 may be stored in the employer data store 214.

The employer application module 204 may create a job listing based on the received job listing information. In one embodiment, a job listing is a database entry that includes at least a job title and company and may be stored at the employer data store 214 for later retrieval and use. The employer application module 204 may create a company profile based on received company information, which may be stored at the employer data store 214 for later retrieval and use.

The employer application module 204 provides candidate profiles, candidate predictions and candidate matches to employer clients 106 and receives feedback from employer clients including whether a match is a good match, whether to send an offer to a candidate, and the like. Candidate profiles, candidate predictions and candidate matches are discussed in more detail below. The employer application module 204 facilitates communications between employer clients 106 and candidate clients 108, for example by providing a messaging interface in the employer application that corresponds to a messaging interface in the candidate application. The messaging interface allows a user of the employer application to view candidates that match a job, send job offers, and facilitate job interviews and application processes.

The candidate application module 206 may be configured to manage communications and data transfer between the automated recruitment engine 102 and candidate clients 108, for example, via the candidate application. In one embodiment, the candidate application is a standalone software application running on a candidate client 108. In another embodiment, the candidate application is a web interface provided by the candidate application module 206 and accessibly by candidate clients 108. The candidate application module 206 receives candidate work history, job preferences, and other candidate information from candidate clients 108 and external data sources 110. Work history is information about one or more previous positions a candidate has held. Work history may include a company name, a job title, a job location, compensation information, benefits, commute information, company information, etc. Job preferences include information about a candidate's preferences for a future job, and may include job titles, type of role (e.g., full time, part time, contract, etc.), job location, remote working preferences, industry preferences, company size preferences, etc. Candidate information is information about a candidate, and may include skills, work experience, education, and other personal information (websites, email address, etc.). Information received by the candidate application module 206 may be stored in the candidate data store 216. The candidate application module 206 may create a candidate profile based on received work history, job preferences and candidate information, which may be stored at the candidate data store 216 for later retrieval and use.

The candidate application module 206 provides employer profiles for matching jobs to candidate clients 108. The candidate application module 206 facilitates communications between employer clients 106 and candidate clients 108, for example by providing a messaging interface in the candidate application that corresponds to the messaging interface in the employer application. The messaging interface allows a user of the candidate application to view matching jobs, job offers, messages, and the like.

The prediction module 208 may be configured to predict a likelihood that a user is a match for one or more job listings based on work history and job information. In one embodiment, the prediction module 208 uses one or more mathematical models to determine a job prediction score for a job listing. In one embodiment, the model is a machine learning model that utilizes a machine learning algorithm that takes as input one or more past job title and company pairs (e.g., work history entries from the candidate data store 216) and provides as output one or more predicted job title and company pairs (e.g., job listings from the employer data store 214) with corresponding job prediction scores.

The mathematical models of the prediction module 208 may be trained by the model training module 207 using training data from the training data store 217. In one embodiment, the machine learning algorithm is a multi-task long short term memory recurrent neural network (MT-LSTM), which provides the advantages of handling variable length inputs and overcomes the challenges of training over large numbers of severely imbalanced training classes. In this embodiment, the job prediction scores are marginal distributions for each predicted job title and company pair. In one embodiment, a job prediction score includes a score for the company and a separate score for the title.

In various embodiments, the marginal distribution vectors are generated at multiple time steps by passing the highest layered hidden state of the MT-LSTM through an activation layer. In one embodiment, the activation layer uses two separate sigmoid projection layers: one for the company marginal distribution and the other for the title marginal distribution. In this embodiment, the sigmoid function provides advantages over other methods such as a softmax function due to the computational complexity of computing the softmax. Using the sigmoid function allows for faster training and increased computational efficiency. In one embodiment, the model includes a sigmoid cross-entropy loss function for objective functions for the company and role prediction tasks. To mitigate class imbalance, each class in the loss function is weighted proportionally to the inverse of the class' frequency of occurrence.

The prediction module 208 uses mathematical rules such as may be defined by parameters of the machine learning model to programmatically calculating the likelihood that a user is a match for a job listing. The machine learning model includes model parameters defining a relationship between a job prediction score and the candidate work history (e.g., including companies and titles) and job listing (e.g., as defined by a company and title). The prediction module 208 provides computer automation in a manner that is different from human-performed techniques, such as by utilizing machine learning system cell weights and biases, projection layer weights and biases, etc. related to title and company data in a combined model, rather than using subjective determinations of a human recruiter.

The training module 207 determines model parameters (e.g., LSTM cell weights and biases, projection layer weights and biases, etc.), such as by applying training data (e.g., input and expected output) through backward and forward passes of the neural network. In the forward pass, outputs are calculated from inputs using the neural network model and compared to expected outputs via error or loss calculation. In the backward pass, the calculated loss is used to modify the parameters of the neural network model in a manner that reduces or minimizes the loss. In one embodiment, the training module determines the model parameters by minimizing a convex combination of the title and company sigmoid cross entropy losses using ADAM. In one embodiment, the training module learns title and company transitions simultaneously (as opposed to training two separate models), which provides advantages. First, title and company predictions are strongly dependent on one another (for example, a hospital is more likely to employ a nurse than it is to employ a graphic designer), so learning both titles and companies simultaneously allows the model to capture and learn from these dependencies in order to make reasonable combined predictions. Moreover, the simultaneous approach allows for faster and more efficient training by avoiding the need to train two separate models and by back-propagating error from two sources into the model parameters. Model parameters may be stored for later retrieval and use in the model data store 218.

The matching module 210 determines one or more matching job listings based on job prediction scores, job preferences, and candidate information for each potential matching job analyzed by the prediction module 208. In one embodiment, the matching module 210 eliminates job listings as potential matches based on job preferences (e.g., location, industry, etc.). In another embodiment, the matching module 210 determines a match score for each potential match based on job preferences. The matching module 210 may also determine a final list of matching jobs. In one embodiment, the matching module 210 provides the list of matching jobs to the employer application module 204 so that employers can review matches and make offers. The employer application module 204 also may be configured to apply artificial intelligence algorithms to review matches and make offers based upon configuration rules corresponding to selection criteria of potential offerees. The selection criteria may be, for example, threshold score levels, rankings, and/or weightings of particular characteristics of importance.

### Determining Job Matches

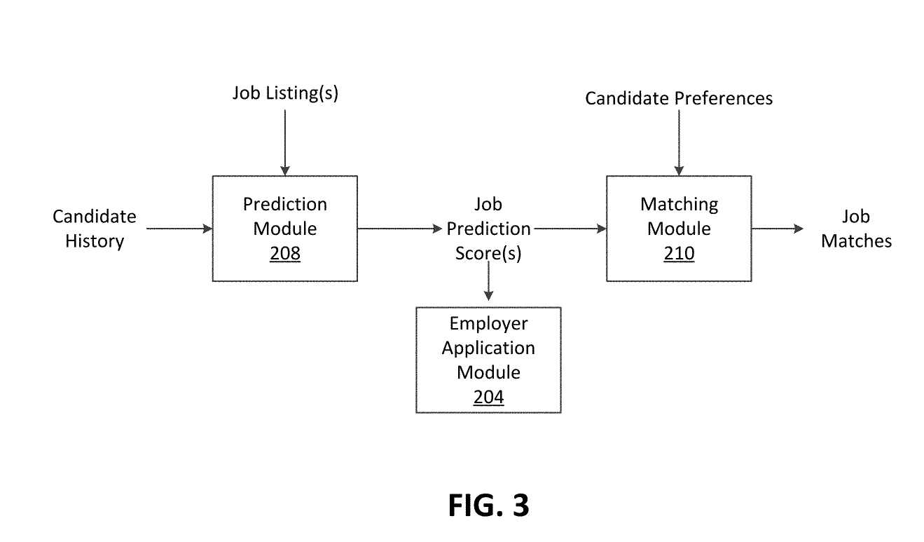

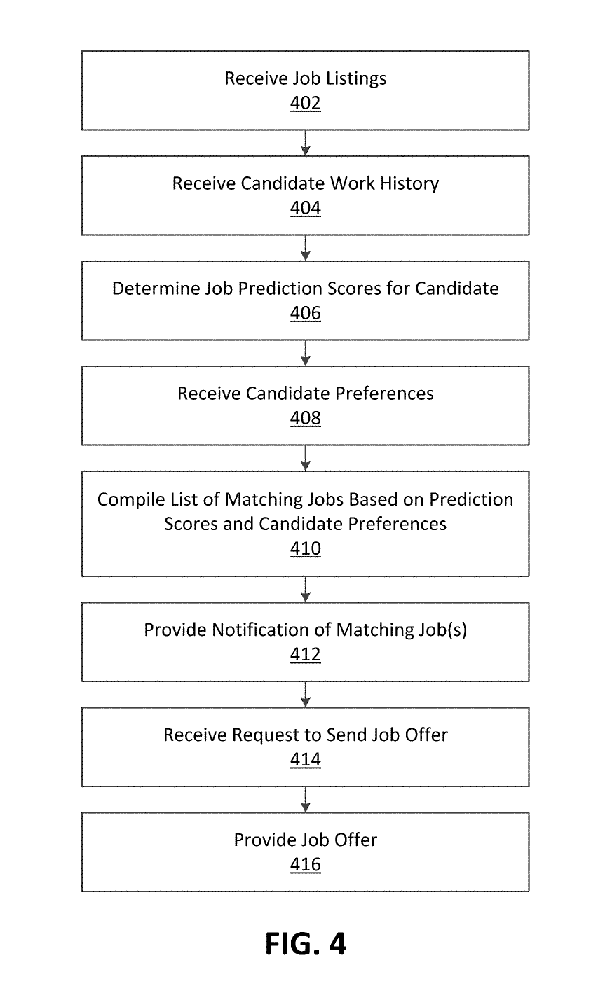

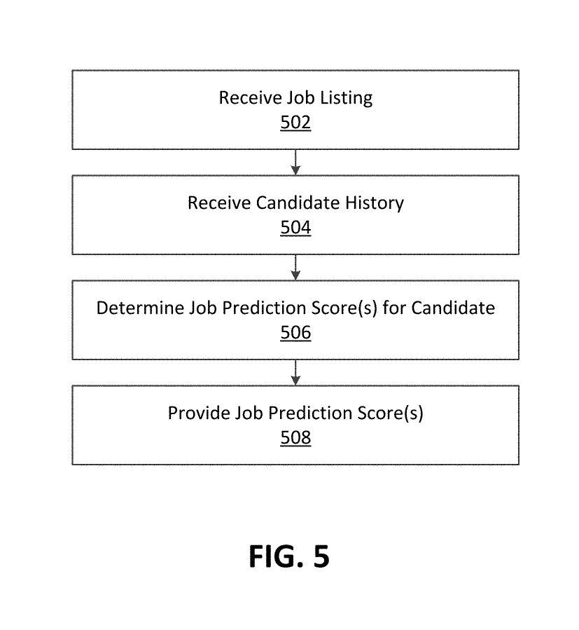

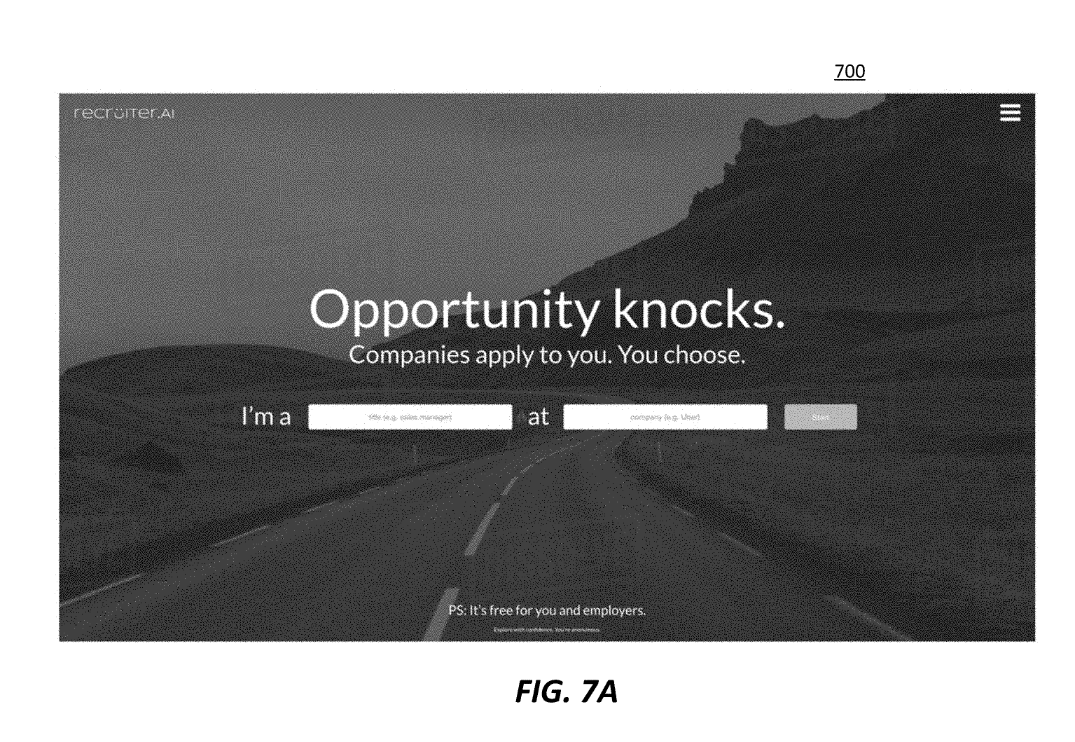

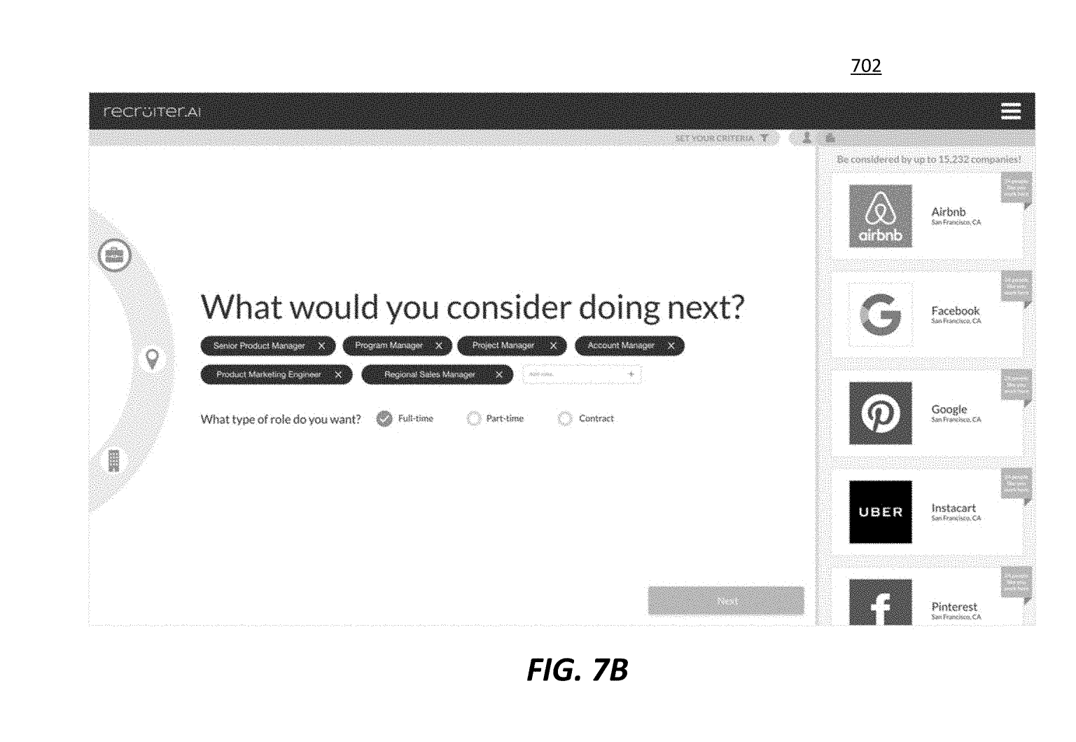

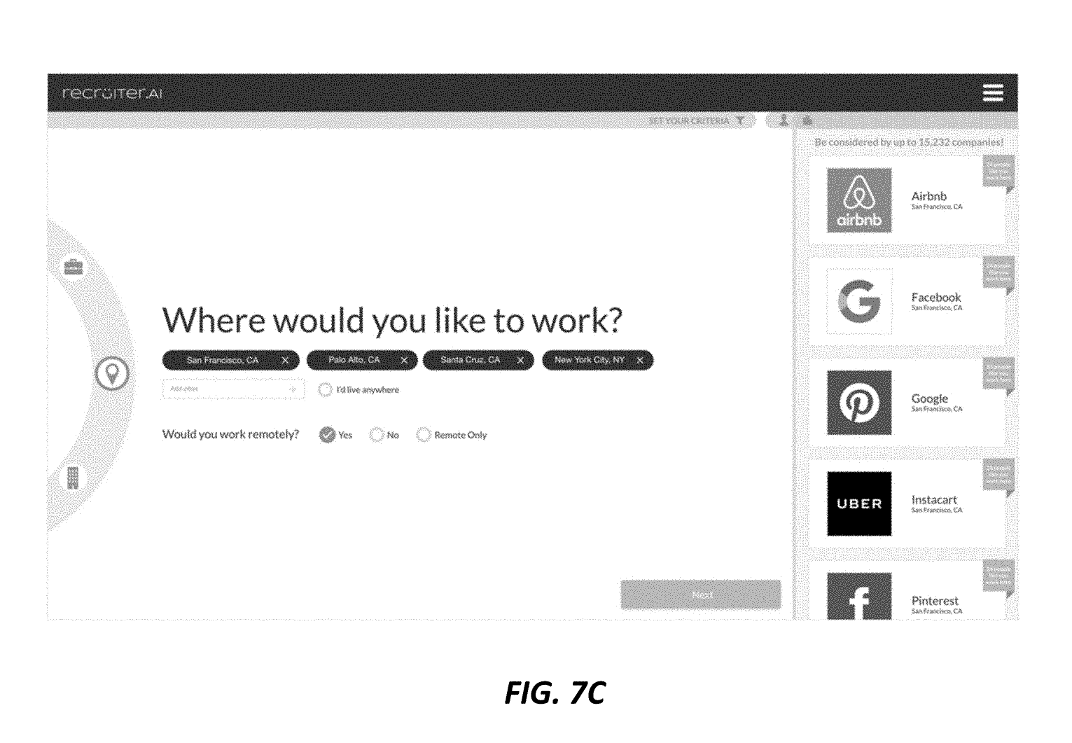

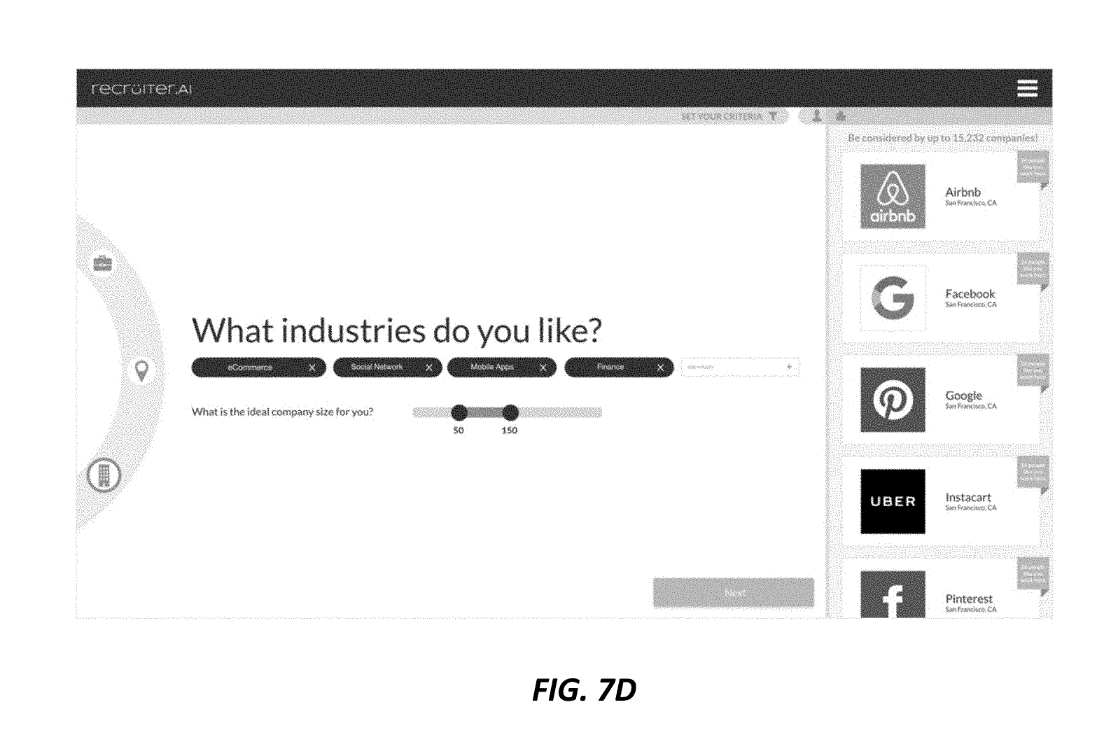

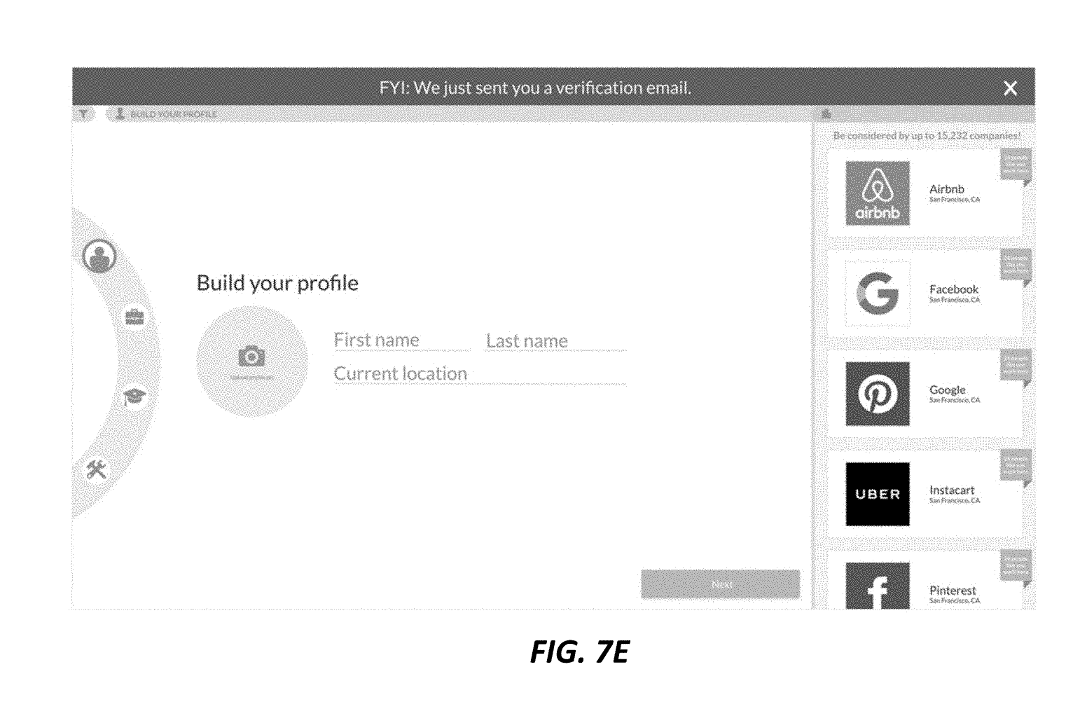

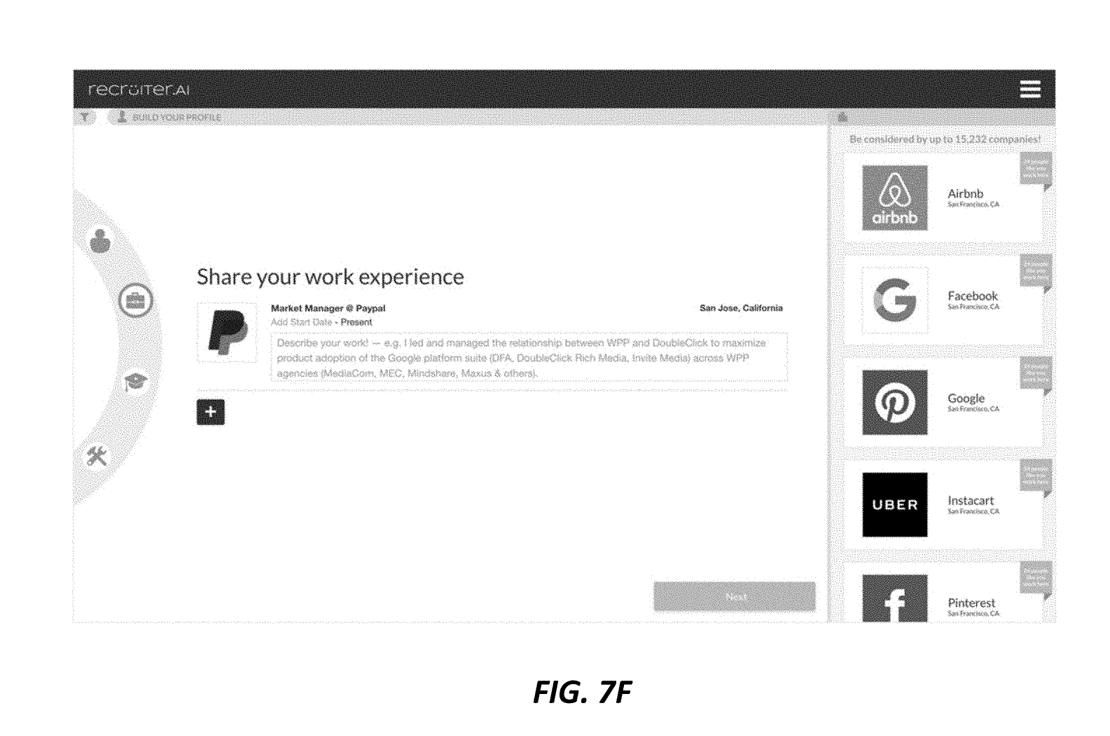

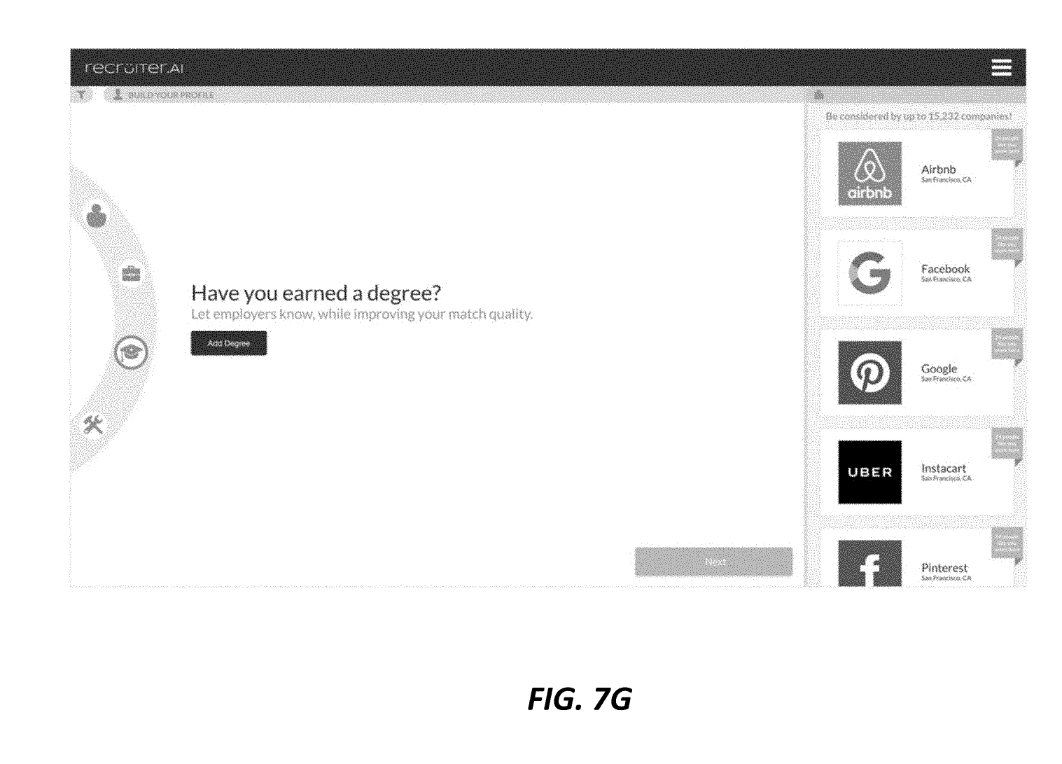

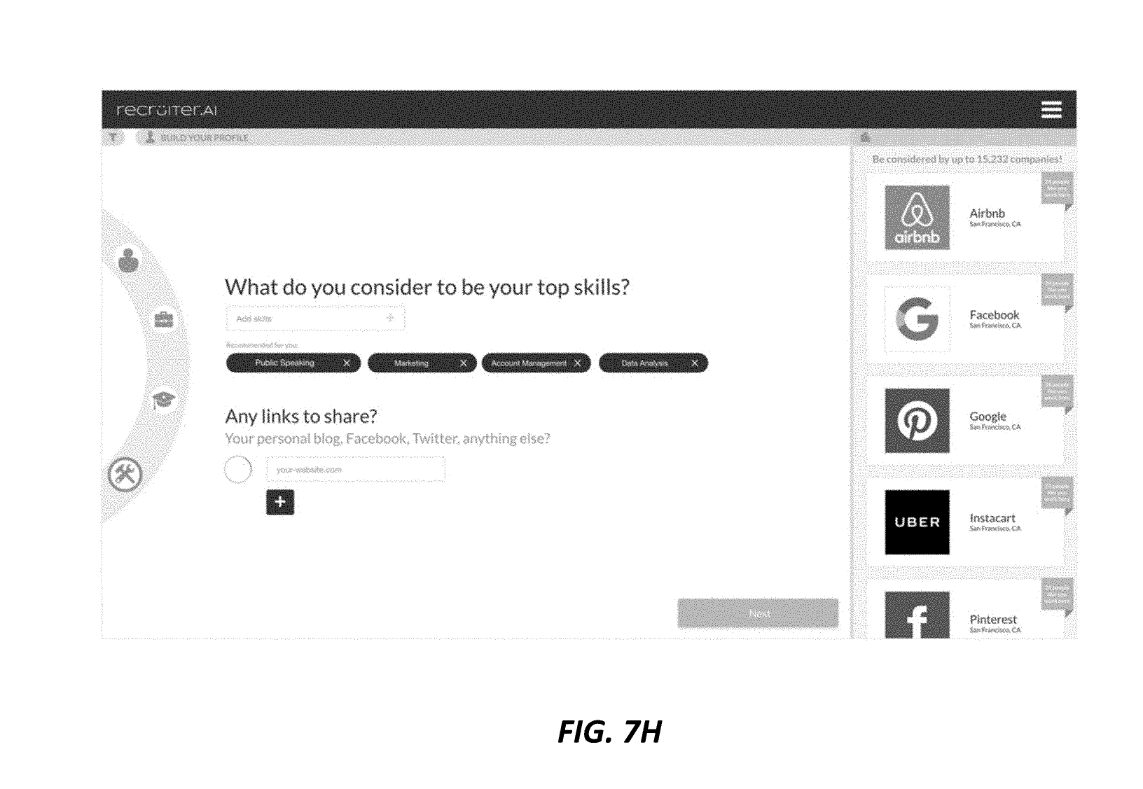

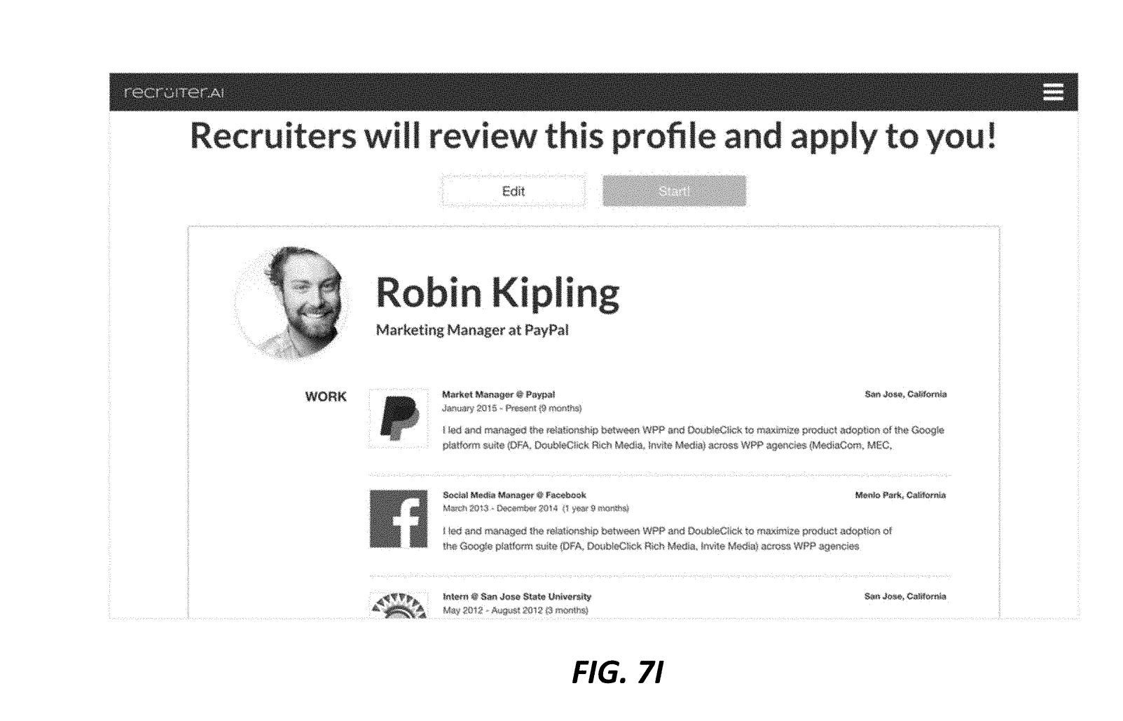

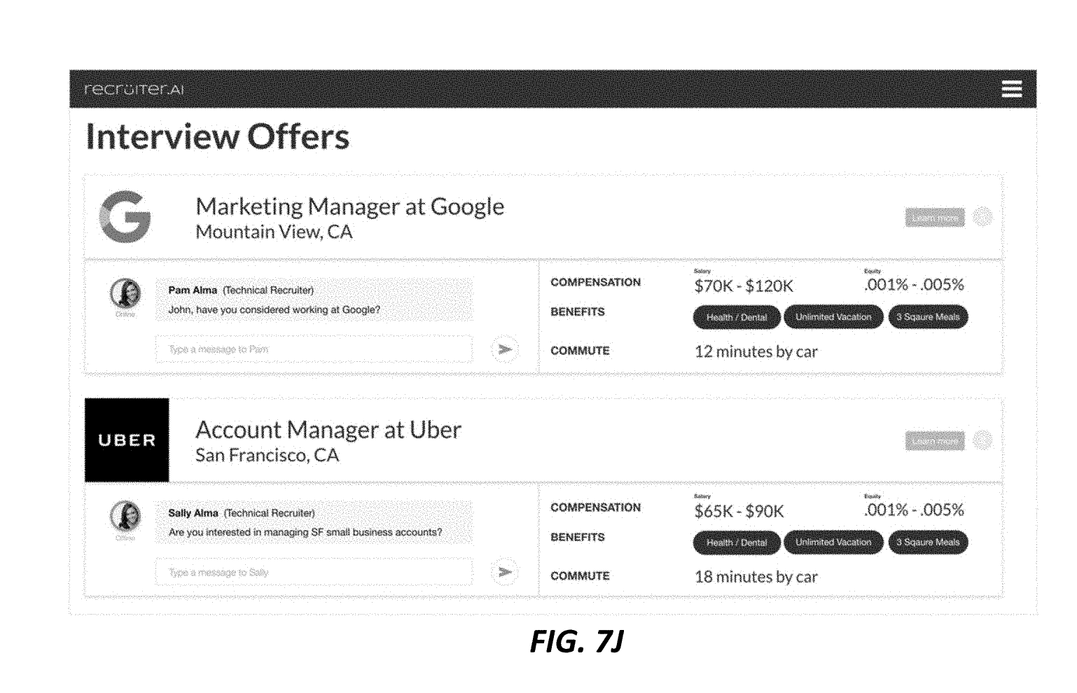

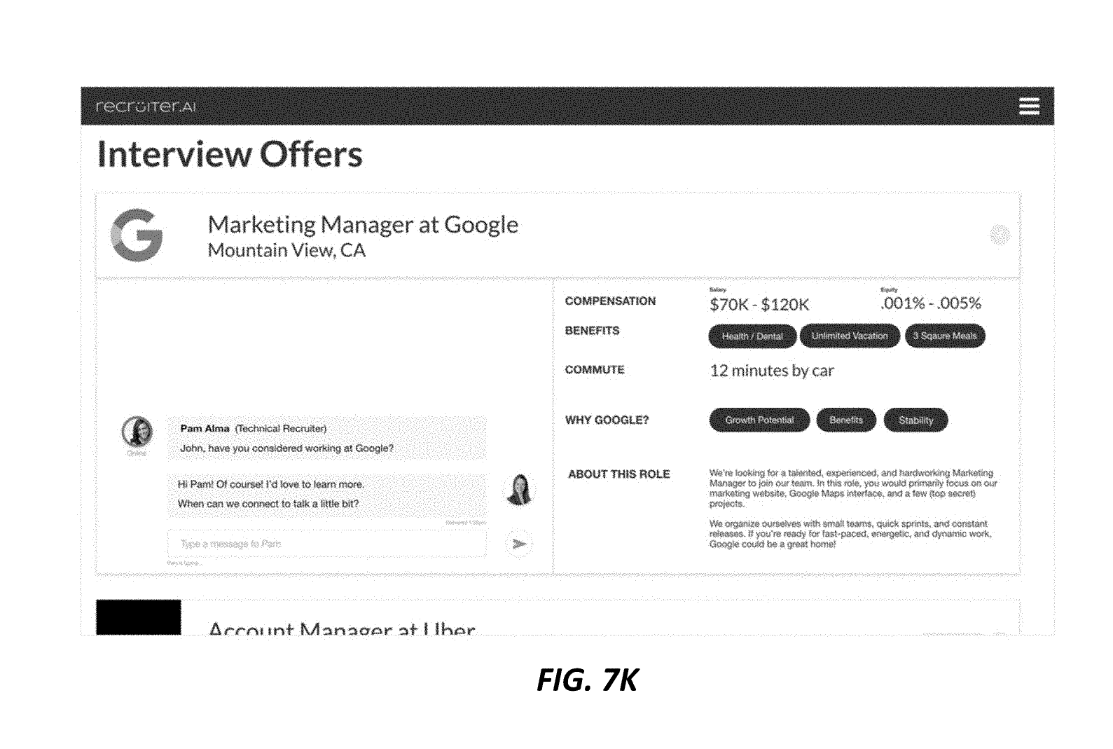

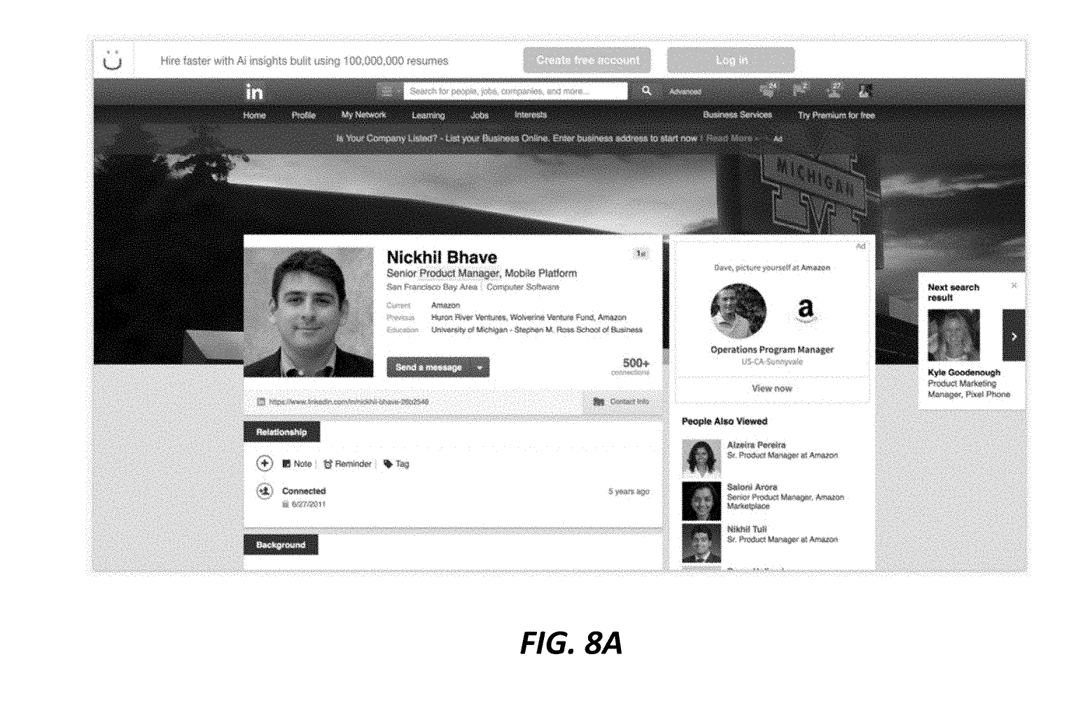

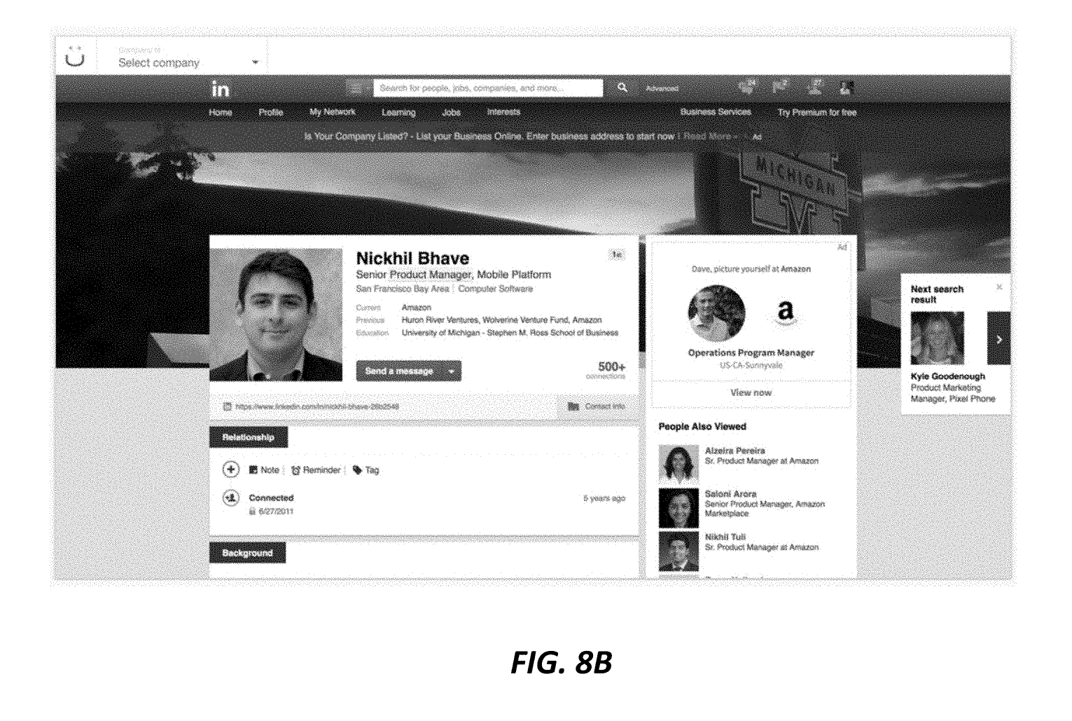

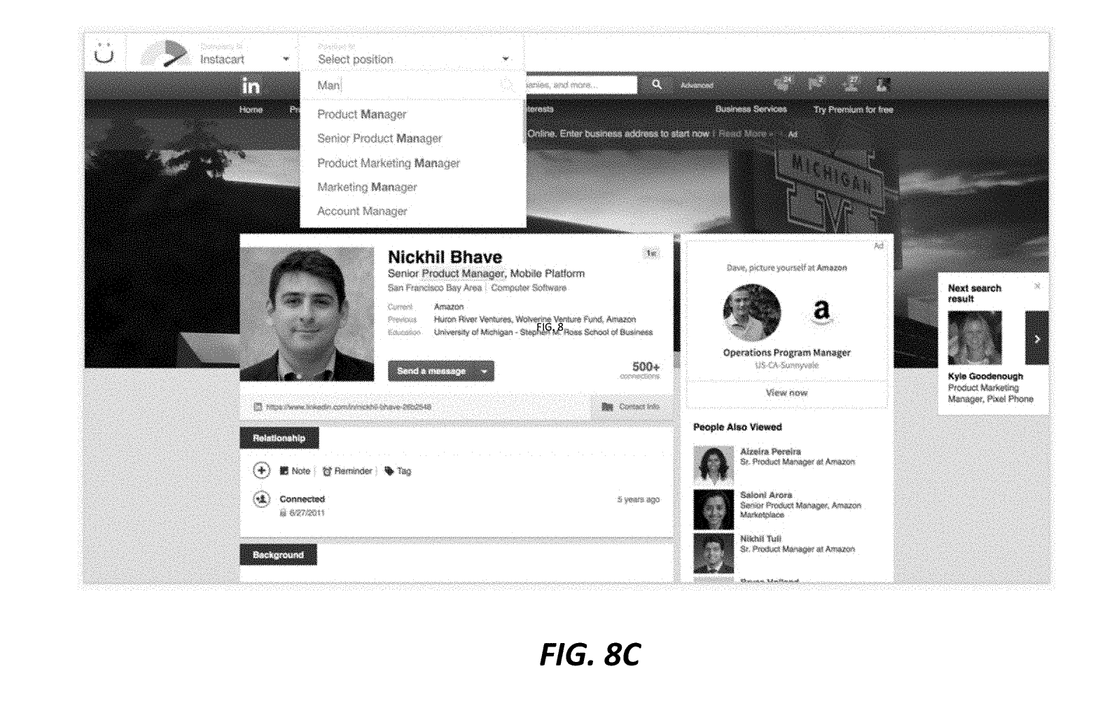

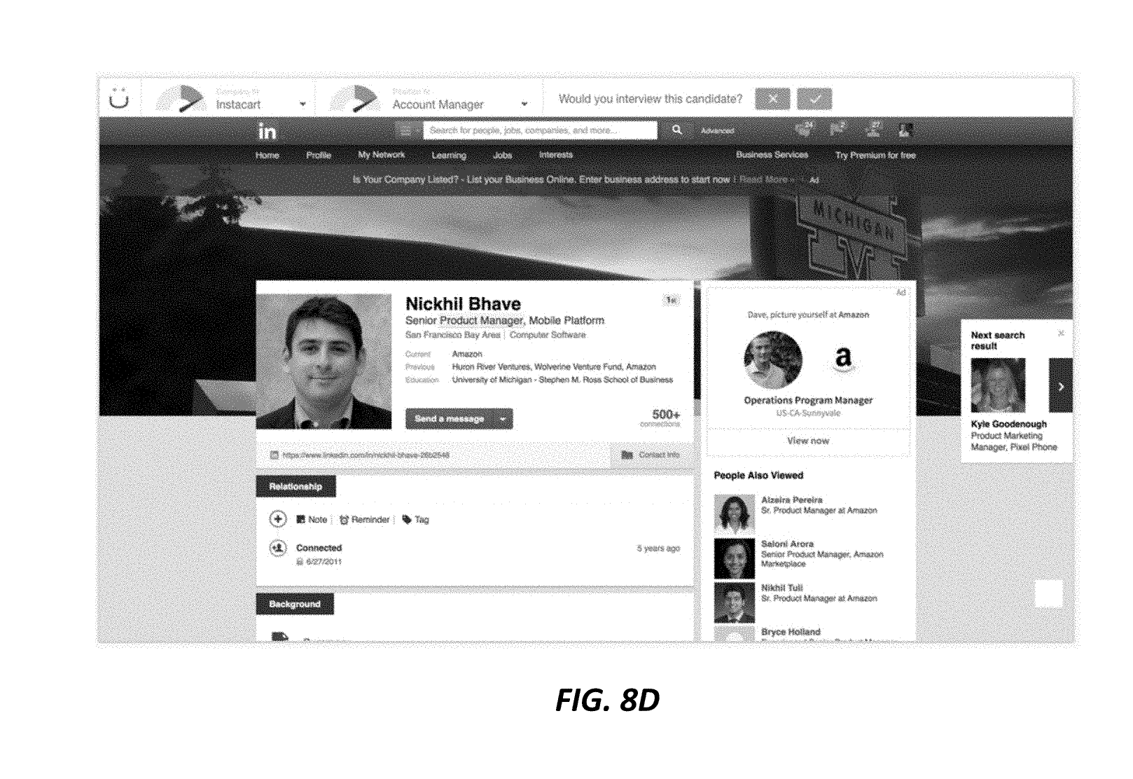

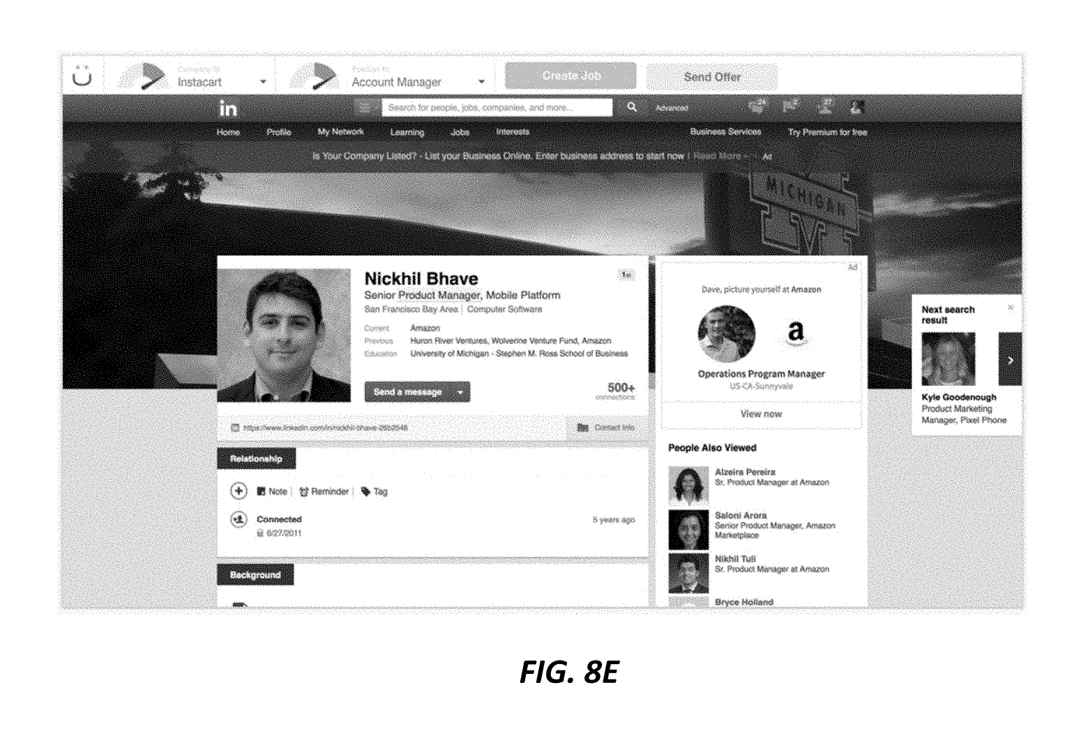

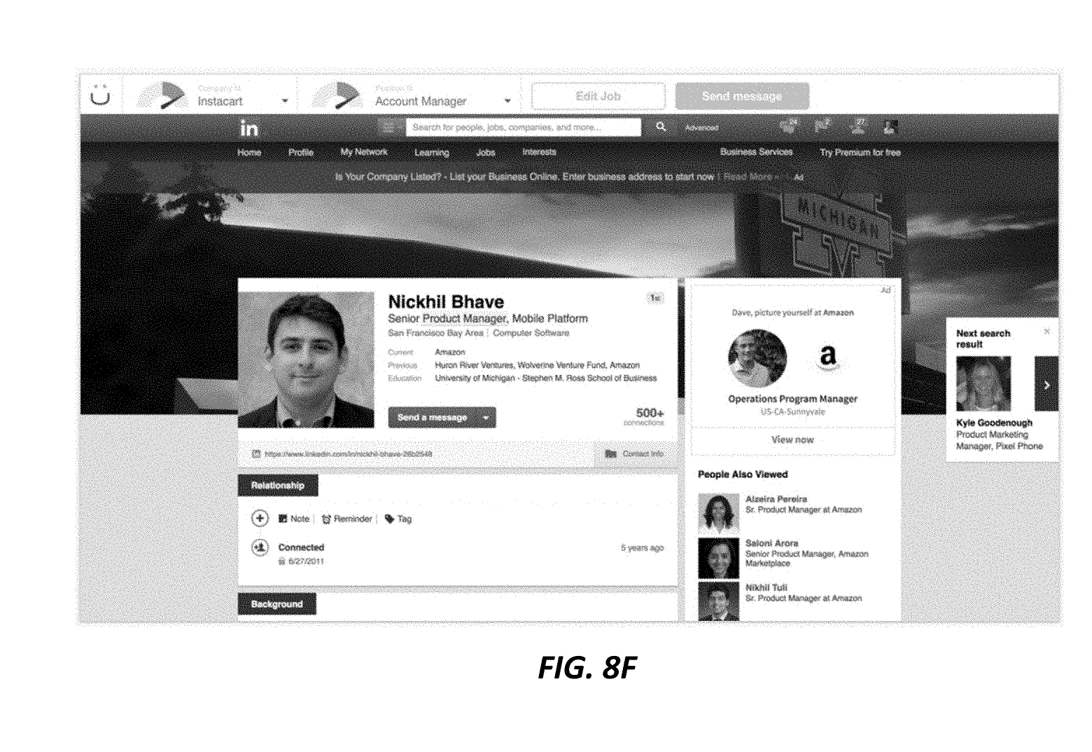

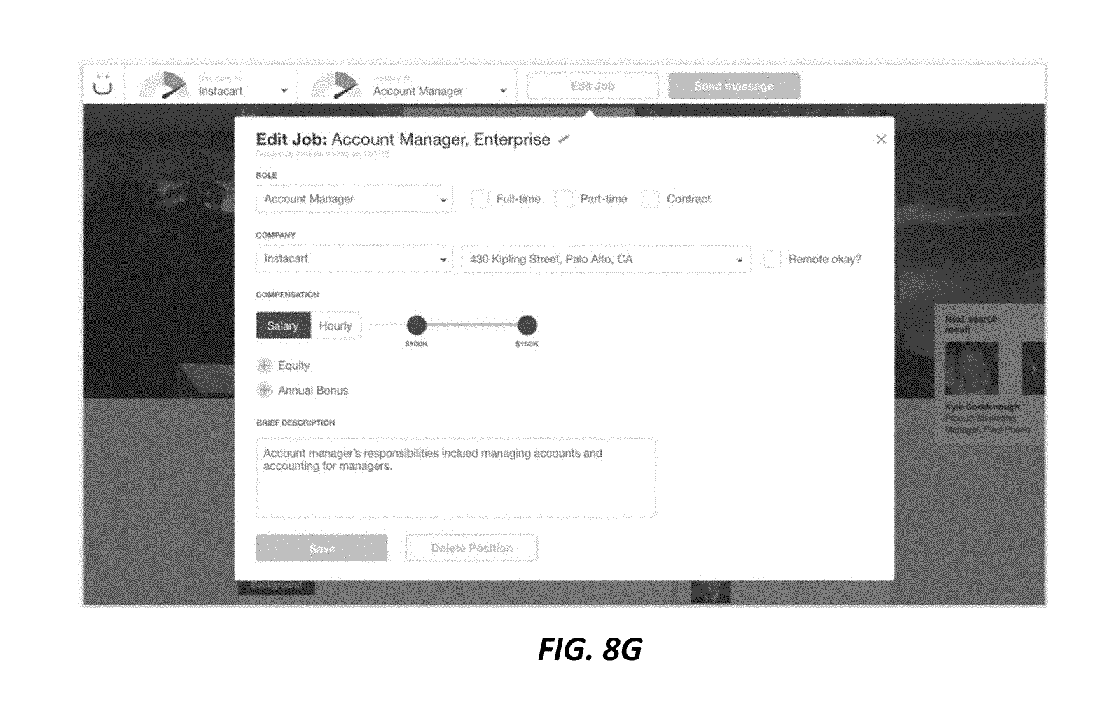

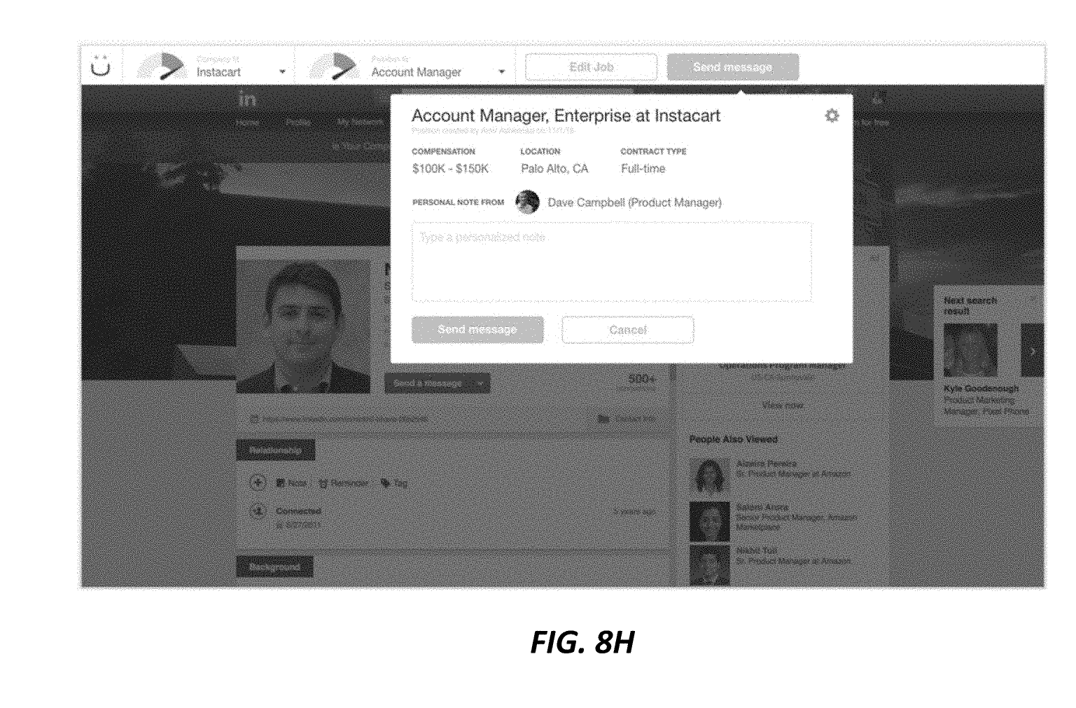

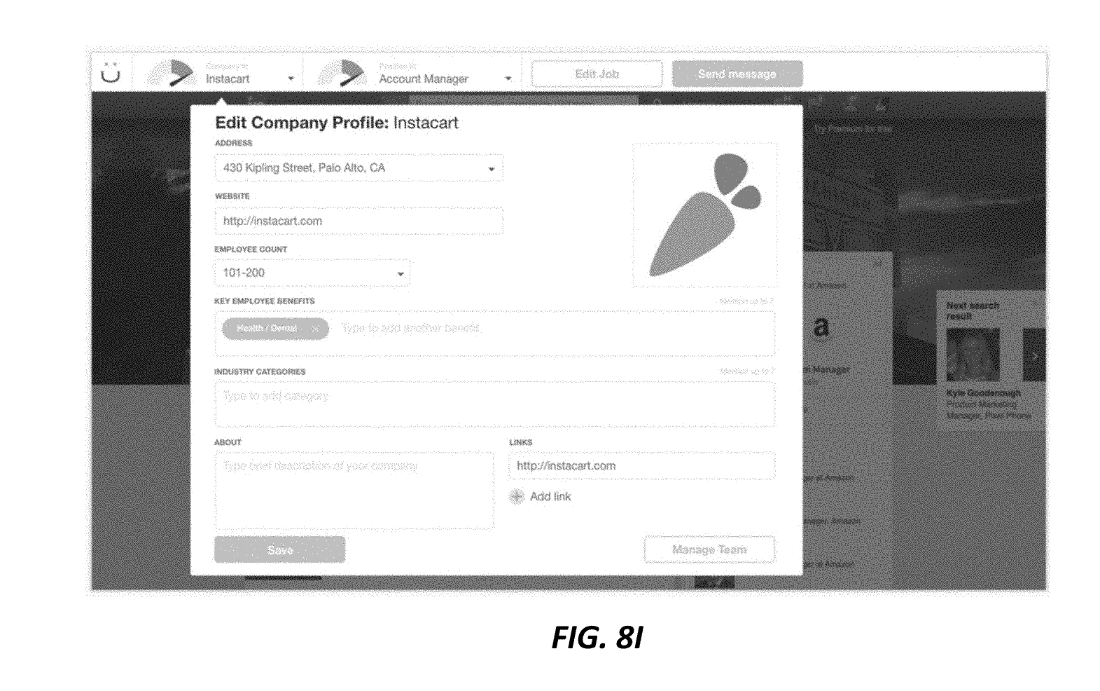

FIG. 3 is a diagram of a process for generating job matches for a candidate, according to one example embodiment. In the example process of FIG. 3, the prediction module receives as inputs the work history of a candidate and one or more job listings. The prediction module 208 determines job prediction scores for each job listing based on the work history. In one embodiment, the job prediction scores are provided to the matching module 210, which determines a list of matching jobs based on the job prediction scores and candidate job preferences. This embodiment is discussed in more detail with respect to FIG. 4 and FIGS. 7A-7K below. In another embodiment, the job prediction scores are provided directly to the employer application module 204 for presentation in the employer application. This embodiment is discussed in more detail below with respect to FIG. 5 and FIGS. 8A-8I.

FIG. 4 is a flowchart of a process for generating job matches for a candidate and facilitating a job offer, according to one example embodiment. The automated recruitment engine 102 receives 402 one or more job listings from employer clients 106. The automated recruitment engine receives 404 a candidate's work history, for example as a company-job title pair from a candidate client 108. The automated recruitment engine 102 determines 406 job prediction scores for one or more of the received job listings. The automated recruitment engine 102 receives 408 candidate job preferences. The automated recruitment engine 102 compiles 410 a list of matching jobs based on the prediction scores and the candidate job preferences. The automated recruitment engine 102 provides 412 notifications to employer clients 106 regarding the matching jobs. The automated recruitment engine 102 receives 414 a request to send a job offer to the candidate and provides 416 the job offer to the candidate. In various embodiments, the job offer includes job listing information and/or company information. This embodiment is discussed in more detail below with respect to FIGS. 7A-7K.

FIG. 5 is a flowchart of a process for determining a job prediction score for a candidate according to one embodiment. The automated recruitment engine 102 receives 502 a job listing from an employer client 106, for example via the employer application. The automated recruitment engine 102 receives 504 a work history for a candidate from a candidate client 108. The automated recruitment engine 102 determines 506 one or more job prediction scores for the candidate and the job listing. The automated recruitment engine 102 provides 508 the job prediction scores to an employer client 106, for example, via the employer application. This embodiment is discussed in more detail below with respect to FIGS. 8A-8I.

### Example Machine Architecture

FIG. 6 is a block diagram illustrating components of an example machine able to read instructions from a machine-readable medium and execute them in a processor (or controller). Specifically, FIG. 6 shows a diagrammatic representation of a machine in the example form of a computer system 600. The computer system 600 can be used to execute program code (or software). The program code comprises instructions (and may include data for use with the instructions) 624. The program code configures a machine to cause the machine to perform any one or more of the methodologies (or processes) described herein, e.g., in FIGS. 1-5. In alternative embodiments, the machine operates as a standalone device or a connected (e.g., networked) device that connects to other machines. In a networked deployment, the machine may operate in the capacity of a server machine or a client machine in a server-client network environment, or as a peer machine in a peer-to-peer (or distributed) network environment.

The machine may be a server computer, a client computer, a personal computer (PC), a tablet PC, a set-top box (STB), a smartphone, an internet of things (IoT) appliance, a network router, switch or bridge, or any machine capable of executing instructions 624 (sequential or otherwise) that specify actions to be taken by that machine. Further, while only a single machine is illustrated, the term “machine” shall also be taken to include any collection of machines that individually or jointly execute instructions 624 to perform any one or more of the methodologies discussed herein.

The example computer system 600 includes one or more processing units (generally processor 602). The processor 602 is, for example, a central processing unit (CPU), a graphics processing unit (GPU), a digital signal processor (DSP), a controller, a state machine, one or more application specific integrated circuits (ASICs), one or more radio-frequency integrated circuits (RFICs), or any combination of these. The computer system 600 also includes a main memory 604. The computer system may include a storage unit 616. The processor 602, memory 604 and the storage unit 616 communicate via a bus 608.

In addition, the computer system 606 can include a static memory 606, a display driver 610 (e.g., to drive a plasma display panel (PDP), a liquid crystal display (LCD), or a projector). The computer system 600 may also include alphanumeric input device 612 (e.g., a keyboard), a cursor control device 614 (e.g., a mouse, a trackball, a joystick, a motion sensor, or other pointing instrument), a signal generation device 618 (e.g., a speaker), and a network interface device 620, which also are configured to communicate via the bus 608.

The storage unit 616 includes a machine-readable medium 622 on which is stored instructions 624 (e.g., software) embodying any one or more of the methodologies or functions described herein. The instructions 624 may also reside, completely or at least partially, within the main memory 604 or within the processor 602 (e.g., within a processor's cache memory) during execution thereof by the computer system 600, the main memory 604 and the processor 602 also constituting machine-readable media. The instructions 624 may be transmitted or received over a network 626 via the network interface device 620.

While machine-readable medium 622 is shown in an example embodiment to be a single medium, the term “machine-readable medium” should be taken to include a single medium or multiple media (e.g., a centralized or distributed database, or associated caches and servers) able to store the instructions 624. The term “machine-readable medium” shall also be taken to include any medium that is capable of storing instructions 624 for execution by the machine and that cause the machine to perform any one or more of the methodologies disclosed herein. The term “machine-readable medium” includes, but not be limited to, data repositories in the form of solid-state memories, optical media, and magnetic media.

### Example User Interfaces for Candidate Application and Employer Application

FIGS. 7A-7K illustrate an example user interface for a candidate application, according to one embodiment. FIG. 7A illustrates an example user interface that includes user input areas for a candidate to provide work history, including a title and a company. FIG. 7B illustrates an example user interface for a candidate to provide job preferences, such as a title and type of role. FIG. 7C illustrates an example user interface for a candidate to provide job preferences including a location and a remote employment preference. FIG. 7D illustrates an example user interface for a candidate to provide job preferences including industry category and company size. FIG. 7E illustrates an example user interface for a candidate to provide candidate information, including name, location and a user photo. FIG. 7F illustrates an example user interface for a candidate to provide candidate information, including work history. FIG. 7G illustrates an example user interface for a candidate to provide candidate information, including education. FIG. 7H illustrates an example user interface for a candidate to provide candidate information, including skills and links. FIG. 7I illustrates an example user interface for a candidate to view and edit a candidate profile generated by the candidate application module 206. FIG. 7J illustrates an example user interface displaying interview offers to a candidate, including job listing information, company information, and a messaging interface. FIG. 7K illustrates an expanded example user interface displaying an interview offer to a candidate, including job listing information, company information, and a messaging interface.

FIGS. 8A-I illustrate an example user interface for employer application that is a web browser extension, according to one embodiment. FIG. 8A illustrates an example user interface for an employer application browser extension that allows an employer to create or log into an account with the automated recruitment engine 102. FIG. 8B illustrates an example user interface for an employer application browser extension that allows an employer to provide a company for a job listing. FIG. 8C illustrates an example user interface for an employer application browser extension that allows an employer to select a position or job title for a job listing. The user interface of FIG. 8C includes a prediction score indicator corresponding to the company and the candidate in the online data source 110 displayed in the web browser. The web extension identifies the candidate as being displayed in the web browser, can instruct the candidate application module 206 or other component of the automated recruitment engine 102 to perform processing associated with the candidate such as accessing candidate work history, determining job prediction scores, etc. In the example of FIG. 8C, the employer application module 204 determines work history from the online data source 110 in real time, e.g., by crawling the page for one or more current job titles and companies. FIG. 8D illustrates an example user interface for an employer application browser extension that includes prediction scores for the company and the job title for the candidate, and an element for soliciting feedback about the quality of the match. FIG. 8E illustrates an example user interface for an employer application browser extension that includes elements to create a job listing based on the entered information. FIG. 8F illustrates an example user interface for an employer application browser extension that includes elements to edit a job listing and send a message to the candidate. FIG. 8G illustrates an example user interface for an employer application browser extension that includes an interface for editing a job listing, including providing job listing information. FIG. 8H illustrates an example user interface for an employer application browser extension that includes an interface for sending a message including the job listing to the candidate. FIG. 8I illustrates an example user interface for an employer application browser extension that includes an interface for editing a company profile associated with the job listing.

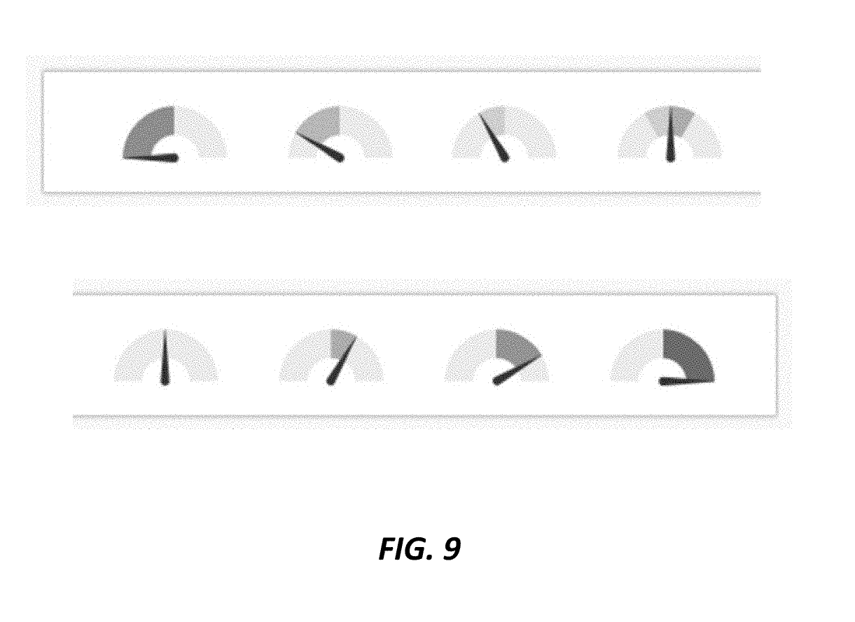

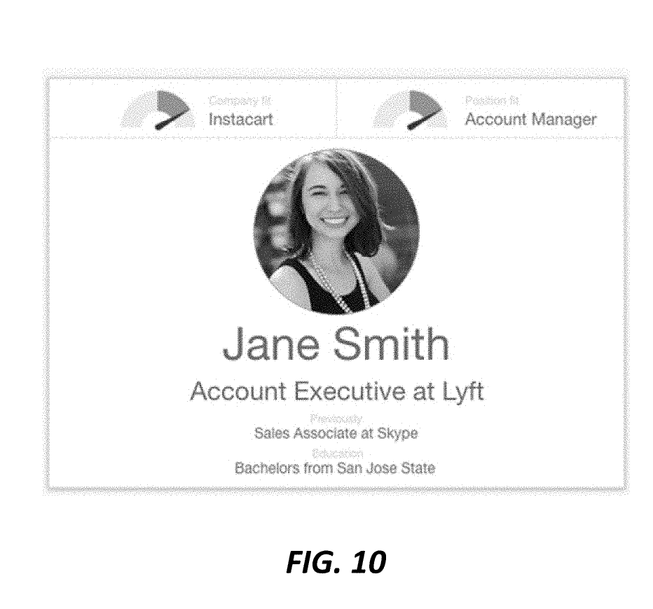

FIG. 9 illustrates example user interface elements for indicating a prediction score, according to one embodiment. FIG. 10 illustrates an example user interface for an employer application that includes candidate information, candidate work history, and prediction score indicators, according to one embodiment.

### Additional Considerations

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, engines, or mechanisms, for example, as illustrated in FIGS. 1-3. Modules may constitute either software modules (e.g., code embodied on a machine-readable medium) or hardware modules. A hardware module is tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

The various operations of example methods described herein, e.g., with FIGS. 4 and 5, may be performed, at least partially, by one or more processors, e.g., processor 602, that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

The one or more processors 602 may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., application program interfaces (APIs).)

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may be capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative structural and functional designs for a system and a process for an automated identification and selection mechanism for candidates in a recruitment process through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

What is claimed is:

1. An automated system for managing recruitment of candidates, comprising:
a candidate application module configured to receive candidate work history corresponding to a candidate, the candidate work history comprising a past job title and a past company name;
an employer application module configured to receive a job listing, the job listing including a listing job title and a listing company name;
a prediction module configured to determine, by applying the candidate work history and job listing to a machine learning model, a job prediction score indicating a measure of whether the job listing is a likely next job for the candidate, the machine learning model including model parameters defining a relationship between the job prediction score and the candidate work history and job listing; and
a matching module configured to determine, based on the job prediction score, whether the candidate is a match for the job listing.

2. The system of claim 1, wherein the job prediction score defines a first marginal distribution of the listing job title and a second marginal distribution of the listing company name.

3. The system of claim 2, wherein the first and second marginal distributions are each defined by a vector generated at multiple time steps by passing a hidden state of a multi-task long short term memory recurrent neural network (MT-LSTM) through an activation layer.

4. The system of claim 3, wherein the activation layer uses a first projection layer for first marginal distribution of the listing job title and a second projection layer for the second marginal distribution of the listing company name.

5. The system of claim 1, further comprising a training module configured to generate the machine learning model.

6. The system of claim 5, wherein the training module generates the machine learning model using a sigmoid cross-entropy loss function for the first and second marginal distributions.

7. The system of claim 6, wherein the training module generates the machine learning model based on minimizing a convex combination of listing job title and listing company name sigmoid cross entropy losses.

8. The system of claim 1, wherein the matching module is configured to determine whether the candidate is a match for the job listing based on filtering the job listing according to job preferences of the candidate.

9. The system of claim 1, wherein the employer application module is configured to provide a web browser extension of an employer application executing on an employer client and receive the job listing from the employer client.

10. The system of claim 9, wherein the web browser extension identifies the candidate from the employer application and instructs the candidate application module to access the candidate work history of the candidate.

11. A method for managing recruitment of candidates, comprising:
receiving candidate work history of a candidate, the candidate work history comprising a past job title and a past company name;
receiving a job listing, the job listing including a listing job title and a listing company name;
determining, by applying the candidate work history and job listing to a machine learning model, a job prediction score indicating a measure of whether the job listing is a likely next job for the candidate, the machine learning model including model parameters defining a relationship between the job prediction score and the candidate work history and job listing; and
determining, based on the job prediction score, whether the candidate is a match for the job listing.

12. The method of claim 11, wherein the job prediction score defines a first marginal distribution of the listing job title and a second marginal distribution of the listing company name.

13. The method of claim 12, wherein the first and second marginal distributions are each defined by a vector generated at multiple time steps by passing a hidden state of a multi-task long short term memory recurrent neural network (MT-LSTM) through an activation layer.

14. The method of claim 13, wherein the activation layer uses a first projection layer for first marginal distribution of the listing job title and a second projection layer for the second marginal distribution of the listing company name.

15. The method of claim 13, further comprising generating the machine learning model.

16. The method of claim 15, wherein generating the machine learning model includes using a sigmoid cross-entropy loss function for the first and second marginal distributions.

17. The method of claim 16, wherein generating the machine learning model includes minimizing a convex combination of listing job title and listing company name sigmoid cross entropy losses.

18. The method of claim 11, further comprising providing a web browser extension of an employer application executing on an employer client and receiving the job listing from the employer client.

19. The method of claim 18, wherein the web browser extension identifies the candidate from the employer application and the method further includes accessing the candidate work history of a candidate based on the identification of the candidate.

20. A non-transitory computer readable medium storing program code comprising instructions that, when executed by a processor, configures the processor to:
receive candidate work history of a candidate, the candidate work history comprising a past job title and a past company name;
receive a job listing, the job listing including a listing job title and a listing company name;
determine, by applying the candidate work history and job listing to a machine learning model, a job prediction score indicating a measure of whether the job listing is a likely next job for the candidate, the machine learning model including model parameters defining a relationship between the job prediction score and the candidate work history and job listing; and
determine, based on the job prediction score, whether the candidate is a match for the job listing.

21. The computer readable medium of claim 20, wherein the job prediction score defines a first marginal distribution of the listing job title and a second marginal distribution of the listing company name.

22. The computer readable medium of claim 21, wherein the first and second marginal distributions are each defined by a vector generated at multiple time steps by passing a hidden state of a multi-task long short term memory recurrent neural network (MT-LSTM) through an activation layer.

23. The computer readable medium of claim 22, wherein the activation layer uses a first projection layer for first marginal distribution of the listing job title and a second projection layer for the second marginal distribution of the listing company name.

24. The computer readable medium of claim 20, wherein the instructions further configure the processor to generate the machine learning model using a sigmoid cross-entropy loss function for the first and second marginal distributions.

25. The computer readable medium of claim 20, wherein the instructions further configure the processor to generate the machine learning model based on minimizing a convex combination of listing job title and listing company name sigmoid cross entropy losses.
